(19) United States
(12) Patent Application Publication
(10) Pub. No.: US 2023/0057082 A1
(43) Pub. Date: Feb. 23, 2023

(54) ELECTRONIC DEVICE, METHOD AND COMPUTER PROGRAM

(71) Applicant: Sony Group Corporation, Tokyo (JP)

(72) Inventors: Giorgio FABBRO, Stuttgart (DE); Stefan UHLICH, Stuttgart (DE); Michael ENENKL, Stuttgart (DE); Thomas KEMP, Stuttgart (DE)

(73) Assignee: Sony Group Corporation, Tokyo (JP)

(21) Appl. No.: 17/875,435

(22) Filed: Jul. 28, 2022

(30) Foreign Application Priority Data
Aug. 19, 2021 (EP) 21192234.9

(51) Int. Cl. G10L 21/0272; G10L 17/02; G10L 15/02; G10L 21/013

(52) U.S. Cl. CPC G10L 21/0272; G10L 17/02; G10L 15/02; G10L 21/013

(57) ABSTRACT

An electronic device having circuitry configured to perform source separation on an audio signal to obtain a separated source and a residual signal, to perform feature extraction on the separated source to obtain one or more processing parameters, and to perform audio processing on a captured audio signal based on the one or more processing parameters to obtain an adjusted separated source.

### CROSS-REFERENCE TO RELATED APPLICATION

The present application claims priority to European Patent Application No. 21192234.9, filed Aug. 19, 2021, the entire contents of which are incorporated herein by reference.

### TECHNICAL FIELD

The present disclosure generally pertains to the field of audio processing, and in particular, to devices, methods and computer programs for audio playback.

### TECHNICAL BACKGROUND

There is a lot of audio content available, for example, in the form of compact disks (CD), tapes, audio data files which can be downloaded from the internet, but also in the form of sound tracks of videos, e.g. stored on a digital video disk or the like, etc.

When a music player is playing a song of an existing music database, the listener may want to sing along. A karaoke device typically consists of a music player, microphone inputs, a means of altering the pitch of the played music, and an audio output. Karaoke and play-along systems provide the technology to remove the original vocals during the played-back song.

Although there generally exist techniques for audio playback, it is generally desirable to improve methods and apparatus for playback of audio content.

### SUMMARY

According to a first aspect, the disclosure provides an electronic device comprising circuit configured to perform source separation on an audio signal to obtain a separated source and a residual signal; perform feature extraction on the separated source to obtain one or more processing parameters; and perform audio processing on a captured audio signal based on the one or more processing parameters to obtain an adjusted separated source.

According to a second aspect, the disclosure provides a method comprising performing source separation on an audio signal to obtain a separated source and a residual signal; performing feature extraction on the separated source to obtain one or more processing parameters; and performing audio processing on a captured audio signal based on the one or more processing parameters to obtain an adjusted separated source.

According to a third aspect, the disclosure provides a computer program comprising instructions which, when the program is executed by a computer, cause the computer to perform source separation on an audio signal to obtain a separated source and a residual signal; perform feature extraction on the separated source to obtain one or more processing parameters; and perform audio processing on a captured audio signal based on the one or more processing parameters to obtain an adjusted separated source.

Further aspects are set forth in the dependent claims, the following description, and the drawings.

### BRIEF DESCRIPTION OF THE DRAWINGS

Embodiments are explained by way of example with respect to the accompanying drawings, in which:

FIG. 1 schematically shows a general approach of audio mixing by means of blind source separation (BSS), such as music source separation (MSS);

FIG. 2 schematically shows an embodiment of a sing-along process based on source separation and feature extraction which extracts useful information from a separated vocal track, in order to improve the sing-along experience;

FIG. 3 schematically shows an embodiment of a process of feature extraction, wherein pitch analysis is performed as the feature extraction described in FIG. 2 above, in order estimate the pitch of the original performance;

FIG. 4 schematically shows an embodiment of a process of audio processing, wherein pitch analysis, vocals pitch comparison and vocals mixing are performed as the audio processing described in FIG. 2 above in order to obtain the user's performance and the adjusted vocals;

FIG. 5 shows in more detail an embodiment of a process of pitch analysis performed in the process of feature extraction and audio processing as described in FIGS. 3 and 4 above, in order to obtain the pitch of the original performance and the user's performance;

FIG. 6a shows in diagram a linear dependence of the gain on the pitch comparison result;

FIG. 6b shows in diagram a dependence of the gain on the pitch comparison result, wherein the value of the gain is a binary value;

FIG. 7 schematically shows an embodiment of a process of feature extraction, wherein reverberation estimation is performed as the feature extraction described in FIG. 2 above in order to give the user, the impression of being in the same space as the original singer;

FIG. 8 schematically shows an embodiment of a process of audio processing, wherein reverberation is performed as the audio processing described in FIG. 2 above in order to give the user, the impression of being in the same space as the original singer;

FIG. 9 schematically shows an embodiment of a process of feature extraction, wherein timbrical analysis is performed as the feature extraction described in FIG. 2 above in order to make the user's vocals sound like the original singer;

FIG. 10 schematically shows an embodiment of a play-along process based on source separation and feature extraction, wherein distortion estimation is performed as feature extraction in order to extract useful information from the guitar signal, which allows the user to play his guitar track with the original guitar effects;

FIG. 11 shows a flow diagram visualizing a method for a generic play/sing-along process based on source separation and feature extraction to obtain a mixed audio signal; and

FIG. 12 shows a block diagram depicting an embodiment of an electronic device that can implement the processes of audio mixing based on an enable signal and audio processing.

### DETAILED DESCRIPTION OF EMBODIMENTS

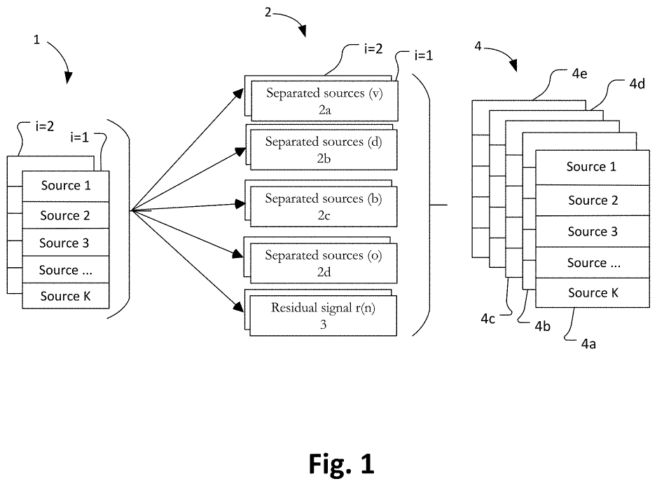

Before a detailed description of the embodiments under reference of FIGS. 1 to 12, some general explanations are made.

As mentioned in the outset, typically, play-along systems, for example karaoke systems, use audio source separation to remove the original vocals during the played-back song. A typical karaoke system performs separates the vocals from the all the other instruments, i.e. instrumental signal, sums the instrumental signal with the user's vocals signal, and plays back the mixed signal. It has been also recognized that extracting information for example, from the original vocals of the audio signal and apply them to the user's vocals signal may be useful in order to obtain an enhanced mixed audio signal, and thus to enhance the user's sing/play-along experience.

Consequently, the embodiments described below in more detail pertain to an electronic device comprising circuitry configured to perform source separation on an audio signal to obtain a separated source and a residual signal, perform feature extraction on the separated source to obtain one or more processing parameters and perform audio processing on a captured audio signal based on the one or more processing parameters to obtain an adjusted separated source.

According to the embodiments, by performing feature extraction not discarding the original vocal signal, information that can be used to enhance the user experience is considered.

The circuitry of the electronic device may include a processor (for example a CPU), a memory (RAM, ROM or the like), a storage, interfaces, etc. Circuitry may also comprise or may be connected with input means (mouse, keyboard, camera, etc.), output means (display (e.g. liquid crystal, (organic) light emitting diode, etc.)), loudspeakers, etc., a (wireless) interface, etc., as it is generally known for electronic devices (computers, smartphones, etc.). Moreover, circuitry may comprise or may be connected with sensors for sensing still images or video image data (image sensor, camera sensor, video sensor, etc.), for sensing environmental parameters, etc.

In audio source separation, an audio signal comprising a number of sources (e.g. instruments, voices, or the like) is decomposed into separations. Audio source separation may be unsupervised (called “blind source separation”, BSS) or partly supervised. “Blind” means that the blind source separation does not necessarily have information about the original sources. For example, it may not necessarily know how many sources the original signal contained, or which sound information of the input signal belong to which original source. The aim of blind source separation is to decompose the original signal separations without knowing the separations before. A blind source separation unit may use any of the blind source separation techniques known to the skilled person. In (blind) source separation, source signals may be searched that are minimally correlated or maximally independent in a probabilistic or information-theoretic sense or on the basis of a non-negative matrix factorization structural constraints on the audio source signals can be found. Methods for performing (blind) source separation are known to the skilled person and are based on, for example, principal components analysis, singular value decomposition, (in)dependent component analysis, non-negative matrix factorization, artificial neural networks, etc. For example, audio source separation may be performed using an artificial neural network such as deep neural network (DNN), without limiting the present disclosure in that regard.

Alternatively, audio source separation may be performed using traditional Karaoke and/or sign/play along techniques, such as Out of Phase Stereo (OOPS) techniques, or the like. For example, the OOPS, which is an audio technique, manipulates the phase of a stereo audio track, to isolate or remove certain components of the stereo mix, wherein phase cancellation is performed. In the phase cancellation, two identical but inverted waveforms summed together such that the one cancels the other out. In such a manner, the vocals signal is for example isolated and removed from the mix.

Although some embodiments use blind source separation for generating the separated audio source signals, the present disclosure is not limited to embodiments where no further information is used for the separation of the audio source signals, but in some embodiments, further information is used for generation of separated audio source signals. Such further information can be, for example, information about the mixing process, information about the type of audio sources included in the input audio content, information about a spatial position of audio sources included in the input audio content, etc.

The audio signal can be an audio signal of any type. It can be in the form of analog signals, digital signals, it can origin from a compact disk, digital video disk, or the like, it can be a data file, such as a wave file, mp3-file or the like, and the present disclosure is not limited to a specific format of the input audio content. An input audio content may for example be a stereo audio signal having a first channel input audio signal and a second channel input audio signal, without that the present disclosure is limited to input audio contents with two audio channels. In other embodiments, the input audio content may include any number of channels, such as remixing of an 5.1 audio signal or the like.

The audio signal may comprise one or more source signals. In particular, the audio signal may comprise several audio sources. An audio source can be any entity, which produces sound waves, for example, music instruments, voice, speech, vocals, artificial generated sound, e.g. origin form a synthesizer, etc.

The input audio content may represent or include mixed audio sources, which means that the sound information is not separately available for all audio sources of the input audio content, but that the sound information for different audio sources, e.g. at least partially overlaps or is mixed.

The separated source produced by source separation from the audio signal may for example comprise a “vocals” separation, a “bass” separation, a “drums” separations and an “other” separation. In the “vocals” separation all sounds belonging to human voices might be included, in the “bass” separation all noises below a predefined threshold frequency might be included, in the “drums” separation all noises belonging to the “drums” in a song/piece of music might be included and in the “other” separation all remaining sounds might be included.

In a case where the separated source is “vocals”, a residual signal may be “accompaniment”, without limiting the present disclosure in that regard. Alternatively, other types of separated sources may be obtained, for example, in an instrument separation case, the separated source may be “guitar”, a residual signal may be “vocals”, “bass”, “drums”, “other”, or the like.

Source separation obtained by a Music Source Separation (MSS) system may result in artefacts such as interference, crosstalk, or noise.

By performing feature extraction on the separated source, for example, on the original vocals signal, useful information, such as one or more processing parameters, may be extracted from the original vocals signal, and thus, the user's sing/play-along experience may be enhanced using karaoke systems, play-back systems, play/sign-along systems and the like.

The processing parameters may be one or more of processing parameters. For example, the one or more processing parameters may be a set of processing parameters. Moreover, the one or more processing parameters may be independent of each other and may be implemented individually or may be combined as multiple features. The one or more processing parameters may be reverberation information, pitch estimation, timbrical information, typical effect chain parameters, e.g. compressor, equalizer, flanger, chorus, delay, vocoder, etc., distortion, delay, or the like, without limiting the present disclosure in that regard. The skilled person may choose the processing parameters to be extracted according to the needs of the specific use case.

Audio processing may be performed on the captured audio signal using an algorithm that the user's captured audio signal in real-time. The captured audio signal may be a user's signal, such as a user's vocals signal, a user's guitar signal or the like. Audio processing may be performed on the captured audio signal, e.g. a user's vocals signal, based on the one or more processing parameters to obtain the adjusted separated source, without limiting the present disclosure in that regard. Alternatively, audio processing may be performed on the captured audio signal, e.g. the user's vocals signal, based on the separated source, e.g. the original vocals signal, and based on the one or more processing parameters, e.g. vocals pitch, to obtain the adjusted separated source, e.g. adjusted vocals.

The adjusted separated source may be adjusted by a gain factor or the like based on the one or more processing parameters and then mixed with the residual signal such that a mixed audio signal is obtained. The captured audio signal may be adjusted by a gain factor or the like based on the one or more processing parameters to obtain an adjusted captured audio signal, i.e. the adjusted separated source. For example, the adjusted separated source may be vocals signal if the separated source is an original vocals signal and the captured audio signal is a user's vocals signal, without limiting the present disclosure in that regard. Alternatively, the adjusted separated source may be guitar signal if the separated source is an original guitar signal and the captured audio signal is a user's guitar signal, without limiting the present disclosure in that regard.

In some embodiments, the circuitry may be further configured to perform mixing of the adjusted separated source with the residual signal to obtain a mixed audio signal. The mixed audio signal may be a signal that comprises the adjusted separated source and the residual signal.

In the following, the terms can refer to the mixing of the separated audio source signals. Hence the “mixing” of the separated audio source signals can result in a “remixing”, “upmixing” or “downmixing” of the mixed audio sources of the input audio content. The terms remixing, upmixing, and downmixing can refer to the overall process of generating output audio content on the basis of separated audio source signals originating from mixed input audio content.

The mixing may be configured to perform remixing or upmixing of the separated sources, e.g. vocals and accompaniment, guitar and remaining signal, or the like, to produce the mixed audio signal, which may be sent to a loudspeaker system of the electronic device, and thus, played back to the user. In this manner, the realism of the user's performance may be increased, because the user's performance may be similar to the original performance.

The processes of source separation, feature extraction, audio processing and mixing may be performed in real-time and thus, the applied effects may change over time, as they follow the original effects from the recording, and thus, the sing/play-along experience may be improved.

In some embodiments, the circuitry may be configured to perform audio processing on the captured audio signal based on the separated source and the one or more processing parameters to obtain the adjusted separated source. For example, the captured audio signal, e.g. a user's vocals signal, may be adjusted by a gain factor or the like based on the one or more processing parameters to obtain an adjusted captured audio signal and then mixed with the separated source, e.g. the original vocals signal, to obtain the adjusted separated source. The adjusted separated source is then mixed with the residual signal such that a mixed audio signal is obtained.

In some embodiments, the separated source comprises original vocals signal, the residual signal comprises accompaniment and the captured audio signal comprises a user's vocals signal.

The accompaniment may be a residual signal that results from separating the vocals signal from the audio input signal. For example, the audio input signal may be a piece of music that comprises vocals, guitar, keyboard and drums and the accompaniment signal may be a signal comprising the guitar, the keyboard and the drums as residual after separating the vocals from the audio input signal, without limiting the present disclosure in that regard. Alternatively, the audio input signal may be a piece of music that comprises vocals, guitar, keyboard and drums and the accompaniment signal may be a signal comprising the vocals, the keyboard and the drums as residual after separating the guitar from the audio input signal, without limiting the present disclosure in that regard. Any combination of separated sources and accompaniment is possible.

In some embodiments, the circuitry may be further configured to perform pitch analysis on the original vocals signal to obtain original vocals pitch as processing parameter and perform pitch analysis on the user's vocals signal to obtain user's vocals pitch. For example, by performing pitch analysis on the original vocals signal, the electronic device may recognize whether the user is singing the main melody or is harmonizing over the original one, and in a case where the user is harmonizing, the electronic device may restore the original separated source signal, e.g. the original vocals signal, the original guitar signal, or the like.

Moreover, by performing or not suppression of the original separated source signal based on whether the user is harmonizing may improve interaction of the user with the electronic device.

In some embodiments, the circuitry may be further configured to perform vocals pitch comparison based on the user's vocals pitch and on the original vocals pitch to obtain a pitch comparison result.

In some embodiments, the circuitry may be further configured to perform vocals mixing of the original vocals signal with the user's vocals signal based on the pitch comparison result to obtain the adjusted vocals signal. Based on the pitch comparison result, a gain may be applied to the user's vocals signal, e.g. the captured audio signal. The gain may have a linear dependency upon the pitch comparison result, without limiting the present embodiment in that regard. Alternatively, the pitch comparison result may serve as a trigger that switches “on” and “off” the gain, without limiting the present embodiment in that regard.

In some embodiments, the circuitry may be further configured to perform reverberation estimation on the original vocals signal to obtain reverberation time as processing parameter. The reverberation estimation may be implemented using an impulse-response estimation algorithm.

In some embodiments, the circuitry may be further configured to perform reverberation on the user's vocals signal based on the reverberation time to obtain the adjusted vocals signal. The audio processing may be implemented as reverberation using for example a simple convolution algorithm. The mixed signal may give the user the impression of being in the same space as the original singer.

In some embodiments, the circuitry may be further configured to perform timbrical analysis on the original vocals signal to obtain timbrical information as processing parameter.

In some embodiments, the circuitry may be further configured to perform audio processing on the user's vocals signal based on the timbrical information to obtain the adjusted vocals signal.

In some embodiments, the circuitry may be further configured to perform effect chain analysis on the original vocals signal to obtain a chain effect parameter as processing parameter. A chain effect parameter may be compressor, equalizer, flanger, chorus, delay, vocoder, or the like.

In some embodiments, the circuitry may be further configured to perform audio processing on the user's vocals signal based on the chain effect parameter to obtain the adjusted vocals signal.

In some embodiments, the circuitry may be further configured to compare the user's signal with the separated source to obtain a quality score estimation and provide a quality score as feedback to the user based on the quality score estimation. The comparison may be a simple comparison between the user's performance and the original vocal signal, and a scoring algorithm that evaluate the user's performance may be used. In this case, the feature extraction process and the audio processing may be not performed, such that the two signals may not be modified.

In some embodiments, the captured audio signal may be acquired by a microphone or instrument pickup. The instrument pickup is for example a transducer that captures, or senses mechanical vibrations produced by musical instruments, such as an electric guitar or the like.

In some embodiments, the microphone may be a microphone of a device such as a smartphone, headphones, a TV set, a Blu-ray player.

In some embodiments, the mixed audio signal may be output to a loudspeaker system.

In some embodiments, the separated source comprises a guitar signal, the residual signal comprises a remaining signal and the captured audio signal comprises a user's guitar signal. The audio signal may be an audio signal which comprises multiple musical instruments. The separated source may be any instrument, such as guitar, bass, drums, or the like and the residual signal may be the remaining signal after separating the signal of the separated source from the audio signal which is input to the source separation.

In some embodiments, the circuitry may be further configured to perform distortion estimation on the guitar signal to obtain a distortion parameter, as processing parameter and perform guitar processing on the user's guitar signal based on the guitar signal and the distortion parameter to obtain an adjusted guitar signal. The present disclosure is not limited in the distortion parameter. Alternatively, parameters such as information about delay, compressor, reverb, or the like may be extracted.

The embodiments also disclose a method comprising performing source separation on an audio signal to obtain a separated source and a residual signal, performing feature extraction on the separated source to obtain one or more processing parameters and performing audio processing on a captured audio signal based on the one or more processing parameters to obtain an adjusted separated source.

The embodiments also disclose a computer program comprising instructions which, when the program is executed by a computer, cause the computer to perform source separation on an audio signal to obtain a separated source and a residual signal, to perform feature extraction on the separated source to obtain one or more processing parameters and to perform audio processing on a captured audio signal based on the one or more processing parameters to obtain an adjusted separated source.

The embodiments also disclose a non-transitory computer-readable recording medium that stores therein a computer program product, which, when executed by a processor, causes source separation to be performed on an audio signal to obtain a separated source and a residual signal, feature extraction to be performed on the separated source to obtain one or more processing parameters and audio processing to be performed on a captured audio signal based on the one or more processing parameters to obtain an adjusted separated source.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

### Audio Source Separation

FIG. 1 schematically shows a general approach of audio mixing by means of blind source separation (BSS), such as music source separation (MSS).

First, source separation (also called “demixing”) is performed which decomposes a source audio signal 1 comprising multiple channels I and audio from multiple audio sources Source 1, Source 2, . . . Source K (e.g. instruments, voice, etc.) into “separations”, here into source estimates 2a-2d for each channel i, wherein K is an integer number and denotes the number of audio sources. In the embodiment here, the source audio signal 1 is a stereo signal having two channels i=1 and i=2. As the separation of the audio source signal may be imperfect, for example, due to the mixing of the audio sources, a residual signal 3 (r(n)) is generated in addition to the separated audio source signals 2a-2d. The residual signal may for example represent a difference between the input audio content and the sum of all separated audio source signals. The audio signal emitted by each audio source is represented in the input audio content 1 by its respective recorded sound waves. For input audio content having more than one audio channel, such as stereo or surround sound input audio content, also a spatial information for the audio sources is typically included or represented by the input audio content, e.g. by the proportion of the audio source signal included in the different audio channels. The separation of the input audio content 1 into separated audio source signals 2a-2d and a residual 3 is performed based on blind source separation or other techniques which are able to separate audio sources.

In a second step, the separations 2a-2d and the possible residual 3 are remixed and rendered to a new loudspeaker signal 4, here a signal comprising five channels 4a-4e, namely a 5.0 channel system. Based on the separated audio source signals and the residual signal, an output audio content is generated by mixing the separated audio source signals and the residual signal taking into account spatial information. The output audio content is exemplary illustrated and denoted with reference number 4 in FIG. 1.

In the following, the number of audio channels of the input audio content is referred to as Mᵢₙ and the number of audio channels of the output audio content is referred to as Mₒᵤₜ. As the input audio content 1 in the example of FIG. 1 has two channels i=1 and i=2 and the output audio content 4 in the example of FIG. 1 has five channels 4a-4e, Mᵢₙ=2 and Mₒᵤₜ=5. The approach in FIG. 1 is generally referred to as remixing, and in particular as upmixing if Mᵢₙ<Mₒᵤₜ. In the example of the FIG. 1 the number of audio channels Mᵢₙ=2 of the input audio content 1 is smaller than the number of audio channels Mₒᵤₜ=5 of the output audio content 4, which is, thus, an upmixing from the stereo input audio content 1 to 5.0 surround sound output audio content 4.

Technical details about source separation process described in FIG. 1 above are known to the skilled person. An exemplifying technique for performing blind source separation is for example disclosed in European patent application EP 3 201 917, or by Uhlich, Stefan, et al. “Improving music source separation based on deep neural networks through data augmentation and network blending.” 2017 IEEE International Conference on Acoustics, Speech and Signal Processing (ICASSP). IEEE, 2017. There also exist programming toolkits for performing blind source separation, such as Open-Unmix, DEMUCS, Spleeter, Asteroid, or the like which allow the skilled person to perform a source separation process as described in FIG. 1 above.

### Sing-Along Process Based on Source Separation and Feature Extraction

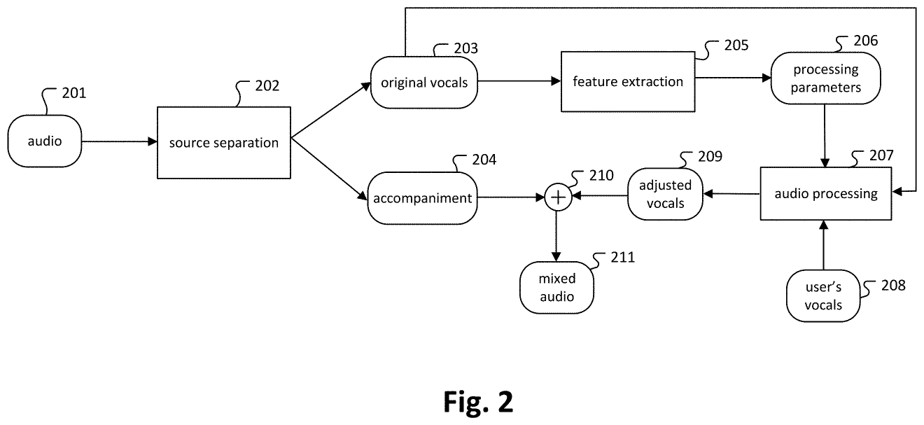

FIG. 2 schematically shows an embodiment of a sing-along process based on source separation and feature extraction which extracts useful information from a separated vocal track, in order to improve the sing-along experience.

Audio 201, i.e. an audio signal (see 1 in FIG. 1) containing multiple sources (see 1, 2, . . . , K in FIG. 1), with, for example, multiple channels (e.g. Mᵢₙ=2) e.g. a piece of music, is input to source separation 202, e.g. audio source separation, and decomposed into separations (see separated sources 2a-2d and residual signal 3 in FIG. 1) as it is described with regard to FIG. 1 above. In the present embodiment, the audio 201 is decomposed into one separated source 2, namely original vocals 203, and into a residual signal 3, namely accompaniment 204, which includes the remaining sources of the audio signal, apart from the original vocals 203. Feature extraction 205 is performed on the original vocals 203, which can be a vocals' audio waveform, to obtain processing parameters 206. Based on the processing parameters 206 and on the original vocals 203, audio processing 207 is performed on user's vocals 208, received by a microphone, to obtain adjusted vocals 209. A mixer 210 mixes the adjusted vocals 209 with the accompaniment 204 to obtain a mixed audio 211.

In the embodiment of FIG. 2, the audio 201 represents an audio signal, the original vocals 203 represents a vocals signal of the audio signal, the accompaniment 204 represents an accompaniment signal, e.g. an instrumental signal, the adjusted vocals 209 represents an adjusted vocals signal and the mixed audio 211 represents a mixed audio signal. The processing parameters 206 is a parameter set comprising information extracted from the separated source, here the original vocals 203. Still further, the skilled person may however choose any number of parameters to be extracted according to the needs of the specific use case, e.g. one or more processing parameters.

The processing parameters 206 may be for example, reverberation information, pitch information, timbrical information, parameters for a typical effect chain, or the like. The reverberation information may be for example reverberation time RT/T₆₀ extracted from the original vocals in order to give the user the impression of being in the same space as the original singer. The timbrical information of the original singer's voice when applied to the user's voice using e.g. a voice cloning algorithm make user's voice sounds like the voice of the original singer. The parameters for a typical effect chain, e.g. information about compressor, equalizer, flanger, chorus, delay, vocoder, etc., is applied to the user's voice to match the original recording's processing.

In the embodiment of FIG. 2, the audio 201 is an original song, comprising all instruments, typically referred to as mixture. The mixture comprises for example vocals and other instruments such as bass, drums, guitar, etc. The feature extraction process is used to extract useful information from the vocals, wherein an algorithm is implemented using the extracted information to alter (adjust) the user's voice in real-time. The altered user's voice, here the adjusted vocals are summed with the accompaniment and the obtained mixed audio signal is played back to the user via a loudspeaker, such as headsets, sound box or the like. The above described extracted features may be applied to the separated source, here vocals, independently from each other, or may be combined as multiple features.

In the embodiment of FIG. 2, the audio processing 207 is performed on the user's vocals 208 based on the processing parameters 206 and based on the original vocals 203 to obtain the adjusted vocals 209, without limiting the present embodiment in that regard. Alternatively, audio processing 207 may be performed on the user's vocals 208 based on the processing parameters 206 to obtain the adjusted vocals 209.

It should be noted that all the above described processes, namely the source separation 202, and the feature extraction 205 can be performed in real-time, e.g. “online” with some latency. For example, they could be directly run on the smartphone, smartwatch of the user/in his headphones, Bluetooth device, or the like.

The source separation 202 process may for example be implemented as described in more detail in published paper Uhlich, Stefan, et al. “Improving music source separation based on deep neural networks through data augmentation and network blending.” 2017 IEEE International Conference on Acoustics, Speech and Signal Processing (ICASSP). IEEE, 2017. There also exist programming toolkits for performing blind source separation, such as Open-Unmix, DEMUCS, Spleeter, Asteroid, or the like which allow the skilled person to perform a source separation process as described in FIG. 1 above.

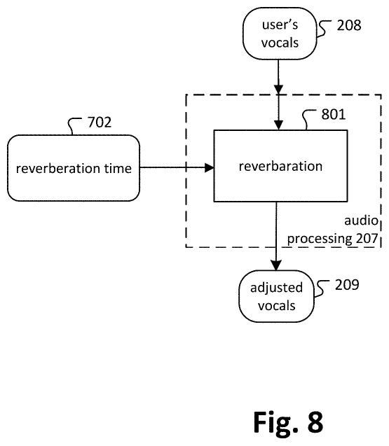

It should be noted that the audio 201 may be an audio signal comprising multiple musical instruments and the source separation 202 process may be performed on the audio signal to separate it to guitar and the remaining signal, as described in FIG. 8 below. Hence, the user may play his guitar track with the original guitar effects.

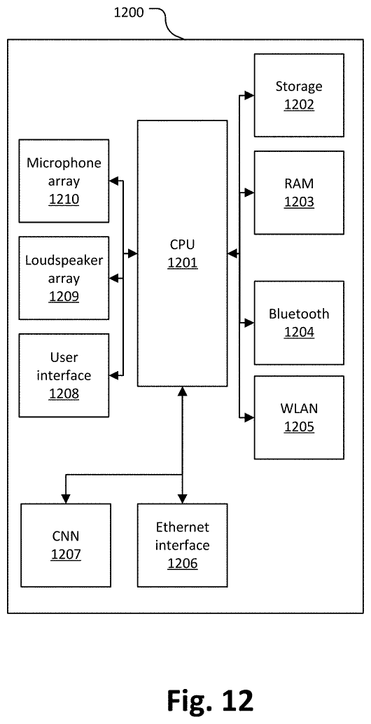

It should be further noted that the user's vocals 208 may be a user's vocals signal captured by a microphone, e.g. a microphone included in a microphone array (see 1210 in FIG. 12). That is, the user's vocals signal may be a captured audio signal.

It should also be noted that there may be an expected latency, for example a time delay Δt, from the feature extraction 205 and audio processing 207. The expected time delay is a known, predefined parameter, which may be applied to the accompaniment signal 204 to obtain a delayed accompaniment signal which then is mixed by the mixer 210 with the adjusted vocals signal 209 to obtain the mixed audio signal 211.

Still further, it should be noted that the accompaniment 204 and/or the mixed audio 211 may be output to a loudspeaker system (see 1209 in FIG. 12), e.g. on-ear, in-ear, over-ear, wireless headphones, etc., and/or may be recorded to a recording medium, e.g. CD, etc., or stored on a memory (see 1202 in FIG. 12) of an electronic device (see 1200 in FIG. 12), or the like. For example, the accompaniment 204 is output to the headphones of the user such the user can sign along with the played-back audio.

Optionally, a quality score may be computed on the user's performance, for example, by running a simple comparison between the user's performance and the original vocal signal, to provide as feedback to the user after the song ended. In this case, the feature extraction process is not performed, e.g. it outputs the input signal, while the audio processing may output the user's vocals signal without modifying it. The audio processing may also compare the original vocals signal and the user's vocals signal and may implement a scoring algorithm that evaluate the user's performance, such that a score is provided to the user as acoustic feedback output by a loudspeaker system (see 1209 in FIG. 12) of an electronic device (see 1200 in FIG. 12), or as visual feedback displayed by a display unit of the electronic device (see 1200 in FIG. 12), or displayed by a display unit of an external electronic device which communicates with the electronic device (see 1200 in FIG. 12) with an Ethernet interface (see 1206 in FIG. 12), a Bluetooth interface (see 1204 in FIG. 12), or a WLAN interface (see 1205 in FIG. 12) included in the electronic device (see 1200 in FIG. 12).

### Sing-Along Process Extracting Pitch Information from a Separated Vocal Track

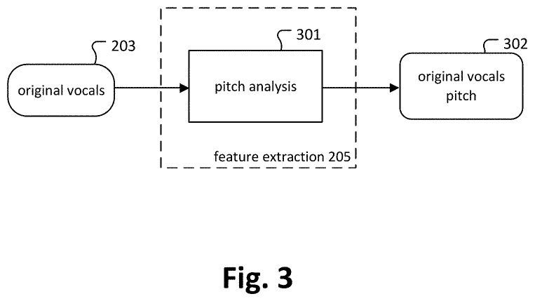

FIG. 3 schematically shows an embodiment of a process of feature extraction, wherein pitch analysis is performed as the feature extraction described in FIG. 2 above, in order estimate the pitch of the original performance.

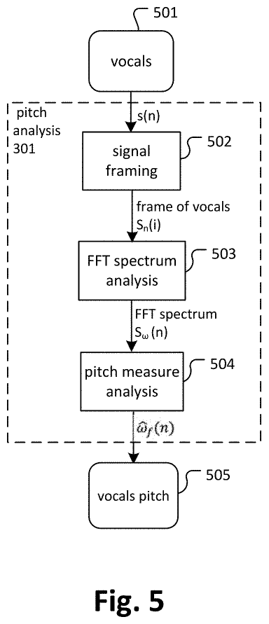

Pitch analysis 301 is performed on the original vocals 203 to obtain original vocals pitch 302. The pitch analysis 301 process is described in more detail in FIG. 5 below. The feature extraction 205 process of FIG. 2 is implemented here as pitch analysis process, wherein the source separation (see 202 in FIG. 2) which is performed on the audio (see 201 in FIG. 2) decomposes the audio in original vocals 203 and accompaniment (see 204 in FIG. 2).

Before performing pitch analysis as feature extraction may be recognized whether the user is singing the main melody of the audio or is harmonizing over the original audio. In case the user is harmonizing, the original vocals may be restored and then pitch analysis is performed to estimate the pitch of the original vocals.

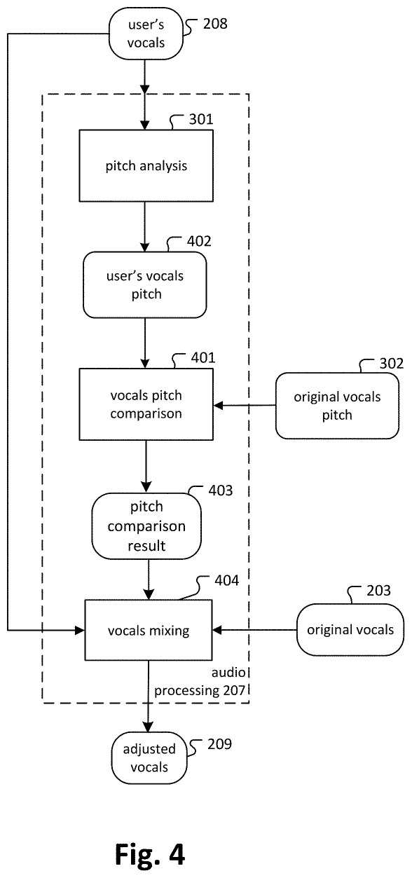

FIG. 4 schematically shows an embodiment of a process of audio processing, wherein pitch analysis, vocals pitch comparison and vocals mixing are performed as the audio processing described in FIG. 2 above in order to obtain the user's performance and the adjusted vocals.

Pitch analysis 301 is performed on the user's vocals 208 to obtain user's vocals pitch 402. The pitch analysis 301 process is described in more detail in FIG. 5 below. Based on the user's vocals pitch 402 and the original vocals pitch 302, vocals pitch comparison 401 is performed to obtain a pitch comparison result 403. The user's vocals pitch 402 and the original vocals pitch 302 are compared to each other and if they do not match, then the original vocals are mixed into the played back signal. Based on the pitch comparison result 403, vocals mixing 404 of the user's vocals 208 with the original vocals 203 is performed to obtain the adjusted vocals 209.

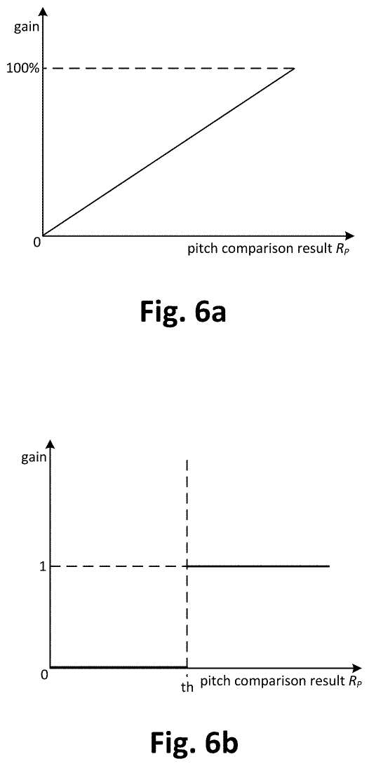

For example, if a difference R_{P} between the user's vocals pitch 402 and the original vocals pitch 302 is more than a threshold th, namely if R_{P}>th, then the process of vocals mixing 404 is performed on the original vocals 203 with the user's vocals 208 to obtain the adjusted vocals 209, which are then mixed with the accompaniment into the played back signal. The value of the difference R_{P} may serve as a trigger that switches “on” or “off” the vocals mixing 404. In this case, a gain applied to the original vocals 203 has two values, namely “0” and “1”, wherein the gain value “0” indicates that the vocals mixing 404 is not performed and the gain value “1” indicates that the vocals mixing 404 is performed, as described in more detail in FIG. 6b below.

Alternatively, the value of the difference R_{P} between the user's vocals pitch 402 and the original vocals pitch 302 may have a linear dependence on a gain which is applied to the original vocals 203, as described in more detail in FIG. 6a below. After applying the suitable gain to the original vocals 203 are mixed with the user's vocals 208 and the accompaniment into the played back signal.

FIG. 5 shows in more detail an embodiment of a process of pitch analysis performed in the process of feature extraction and audio processing as described in FIGS. 3 and 4 above, in order to obtain the pitch of the original performance and the user's performance.

As described in FIGS. 3 and 4, a pitch analysis 301 is performed on the vocals 501, namely on a vocals signal s(n), to obtain a pitch analysis result ω_{f}, here vocals pitch 505. The vocals 501 represents the user's vocals (see 208 in FIGS. 2 and 3) and the original vocals (see 203 in FIGS. 3 and 4). In particular, a process of signal framing 502 is performed on vocals 501, namely on a vocals signal s(n), to obtain framed vocals Sₙ(i). A process of Fast Fourier Transform (FFT) spectrum analysis 503 is performed on the framed vocals Sₙ(i) to obtain the FFT spectrum S_{ω}(n). A pitch measure analysis 504 is performed on the FFT spectrum S_{ω}(n) to obtain vocals pitch 505.

At the signal framing 502, a windowed frame, such as the framed vocals Sₙ(i) can be obtained by

Sₙ(i)=s(n+i)h(i)

where s(n+i) represents the discretized audio signal (i representing the sample number and thus time) shifted by n samples, h(i) is a framing function around time n (respectively sample n), like for example the hamming function, which is well-known to the skilled person.

At the FFT spectrum analysis 503, each framed vocals is converted into a respective short-term power spectrum. The short-term power spectrum S(ω) as obtained at the Discrete Fourier transform, also known as magnitude of the short-term FFT, which may be obtained by

$$\vert {S}_{ω} ( n ) \vert = \vert {\sum }_{i = 0}^{N - 1} {S}_{n} ( i ) e \frac{j 2 πω}{N} \vert$$

where Sₙ(i) is the signal in the windowed frame, such as the framed vocals Sₙ(i) as defined above, ω are the frequencies in the frequency domain, |S_{ω}(n)| are the components of the short-term power spectrum S(ω) and N is the numbers of samples in a windowed frame, e.g. in each framed vocals.

The pitch measure analysis 504 may for example be implemented as described in the published paper Der-Jenq Liu and Chin-Teng Lin, “Fundamental frequency estimation based on the joint time-frequency analysis of harmonic spectral structure” in IEEE Transactions on Speech and Audio Processing, vol. 9, no. 6, pp. 609-621, September 2001:

The pitch analysis result \hat{ω}_{f}(n), i.e. vocals pitch 505, for frame window Sₙ is obtained by

\hat{ω}_{f}(n)=arg^{max}_{ω}_{_{f}}R_{P}(ω_{f})

where \hat{ω}_{f}(n) is the fundamental frequency for window S(n), and R_{P}(ω_{f}) is the pitch measure for fundamental frequency candidate ω_{f} obtained by the pitch measure analysis 504, as described above.

The fundamental frequency \hat{ω}_{f}(n) at sample n indicates the pitch of the vocals at sample n in the vocals signal s(n).

A pitch analysis process as described with regard to FIG. 5 above is performed on the user's vocals 208 to obtain a user's vocals pitch 402 and on the original vocals 203 to obtain an original vocals pitch 302.

In the embodiment of FIG. 5, it is proposed to perform pitch measure analysis, such as the pitch measure analysis 504, for estimating the fundamental frequency ω_{f}, based on FFT-spectrum. Alternatively, the fundamental frequency ω_{f} may be estimated based on a Fast-Adaptive Representation (FAR) spectrum algorithm, without limiting the present disclosure to that regard.

FIG. 6a shows in diagram a linear dependence of the gain on the pitch comparison result R_{P}. The abscissa displays the values of the pitch comparison result 403, i.e. the difference R_{P} between the user's vocals pitch 402 and the original vocals pitch 302. The ordinate displays the value of the gain in the interval 0 to 100%. In FIG. 6a, the horizontal dashed lines represent the maximum value of the gain applied to the original vocals.

In particular, the gain is preset to 0, before pitch comparison is performed. A value of gain equal to 0 indicates that there is no mixing of the original vocals signal to the separated source, here to the user's vocals signal (i.e. captured audio signal). The value of gain increases linearly from 0 to 100%, as the value of the difference R_{P} between the user's vocals pitch and the original vocals pitch, i.e. the pitch comparison result (see 403 in FIG. 4), increases. During the audio processing, wherein the pitch comparison result is obtained, the gain is applied to the original vocals signal based on the value of the difference R_{P} between the user's vocals pitch and the original vocals. That is, as the difference R_{P} between the user's vocals pitch and the original vocals pitch grows larger more of the original vocals signal is mixed to the user's vocals signal.

FIG. 6b shows in diagram a dependence of the gain on the pitch comparison result R_{P}, wherein the value of the gain is a binary value. The abscissa displays the values of the pitch comparison result, i.e. the values of the difference R_{P} between the user's vocals pitch and the original vocals pitch. The ordinate displays the values of the gain, namely “0” and “1”. In FIG. 6b, the horizontal dashed lines represent the maximum value of the gain, namely “1” and the vertical dashed lines represent the value of the threshold th. The value of the difference R_{P} may serve as a trigger that switches “on” or “off” the vocals mixing (see 404 in FIG. 4). In the embodiment of FIG. 6b, the gain applied to the original vocals has two values, namely “0” and “1”, wherein the gain value “0” indicates that the vocals mixing is not performed and the gain value “1” indicates that the vocals mixing is performed.

It should be noted that the dependences of the pitch comparison result upon the gain described in the embodiments of FIGS. 6a and 6b above do not limit the present disclosure in that regard. Any other dependence of the pitch comparison result upon the gain may be used by the skilled person according to the needs of the specific use case.

### Sing-Along Process Extracting Reverberation Information from a Separated Vocal Track

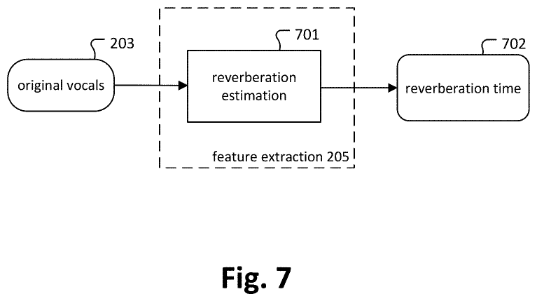

FIG. 7 schematically shows an embodiment of a process of feature extraction, wherein reverberation estimation is performed as the feature extraction described in FIG. 2 above in order to give the user, the impression of being in the same space as the original singer.

Reverberation estimation 601 is performed on the original vocals 203 to obtain reverberation time 702. The feature extraction 205 process of FIG. 2 is implemented here as reverberation estimation process, wherein the source separation (see 202 in FIG. 2) which is performed on the audio (see 201 in FIG. 2) decomposes the audio in original vocals 203 and accompaniment (see 204 in FIG. 2).

The reverberation time is a measure of the time required for the sound to “fade away” in an enclosed area after the source of the sound has stopped. The reverberation time may for example be defined as the time for the sound to die away to a level 60 dB below its original level (T₆₀ time).

The reverberation estimation 601 may for example be estimated as described in the published paper Ratnam R, Jones D L, Wheeler B C, O'Brien W D Jr, Lansing C R, Feng A S. “Blind estimation of reverberation time” J Acoust Soc Am. 2003 November; 114(5):2877-92:

The reverberation time T₆₀ (in seconds) is obtained by

$${T}_{60} = 6 / {log}_{10} ( {e}^{- 1} ) {log}_{e} ( {a}_{d} ) = - 6 {τ}_{d} / {log}_{10} ( {e}^{- 1} ) = 13. 82 {τ}_{d}$$

where τ_{d} is the decay rate of an integrated impulse response curve, and a_{d} is a geometric ratio related to the decay rate τ_{d}, by a_{d}=exp(−1/τ_{d}).

Alternatively, the reverberation time RT/T₆₀ may be estimated as described in the published paper J. Y. C. Wen, E. A. P. Habets and P. A. Naylor, “Blind estimation of reverberation time based on the distribution of signal decay rates,” 2008 IEEE International Conference on Acoustics, Speech and Signal Processing, 2008, pp. 329-332:

The reverberation time RT is obtained by

RT=3ln10/δ

where δ is a damping constant related to the reverberation time RT.

As described above, reverberation time is extracted as reverberation information from the original vocals in order to give the user the impression of being in the same space as the original singer. In this case, the reverberation estimation 701 process implements an impulse-response estimation algorithm as described above, and then vocals processing (see 801 in FIG. 8) may perform a convolution algorithm, which may have an effective and realistic result in a case where the original song was recorded for example live in a concert.

Yet alternatively, in a case where room dimensions are known, the reverberation time T₆₀ may be determined by the Sabine equation

$${T}_{60} = \frac{24 ln {10}^{1}}{{c}_{20}} \frac{V}{S a} \approx 0.1 \; 611 {sm}^{- 1} \frac{V}{S a}$$

where c₂₀ is the speed of sound in the room (for 20 degrees Celsius), V is the volume of the room in m³, S is the total surface area of room in m², a is the average absorption coefficient of room surfaces, and the product Sa is the total absorption. That is, in the case that the parameters V, S, a of the room are known (e.g. in a recording situation), the T₆₀ time can be determined as defined above.

Still alternatively, the reverberation time may be obtained from knowledge about the audio processing chain that produced the input signal (for example the reverberation time may be a predefined parameter set in a reverberation processer, e.g. algorithmic or convolution reverb used in the processing chain).

FIG. 8 schematically shows an embodiment of a process of audio processing, wherein reverberation is performed as the audio processing described in FIG. 2 above in order to give the user, the impression of being in the same space as the original singer.

Reverberation 801 is performed on the user's vocals 208 based on the reverberation time 702 to obtain the adjusted vocals 209. The reverberation 801 performs a convolution algorithm, such as an algorithmic reverb or a convolutional reverb, which may have an effective and realistic result in a case where the original song was recorded for example live in a concert.

### Sing-Along Process Extracting Timbrical Information from a Separated Vocal Track

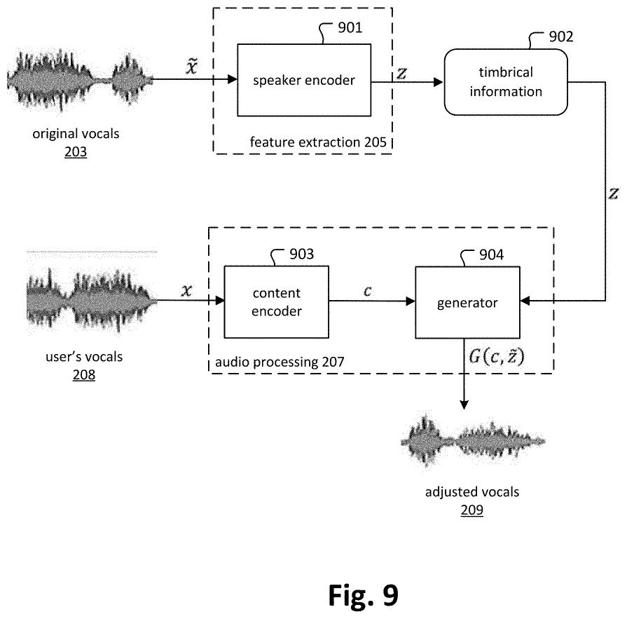

FIG. 9 schematically shows an embodiment of a process of feature extraction, wherein timbrical analysis is performed as the feature extraction described in FIG. 2 above in order to make the user's vocals sound like the original singer. In the embodiment of FIG. 9, a speaker encoder 901 implements the timbrical analysis performed on the original vocals signal 203 to obtain timbrical information 902.

The original vocals 203, i.e. utterance \tilde{x} is input to the speaker encoder which performs timbrical analysis 901 on the original vocals 203 to obtain timbrical information 902, e.g. speaker identity z. The timbrical information 902, namely the speaker identity z, is input to a generator 904. The user's vocals 208, i.e. utterance x is input to a content encoder 903 to obtain a speech content c. The speech content c is input to the generator 904. Based on the speech content c and the speaker identity z, the generator 904 maps the content and speaker embeddings back to raw audio, i.e. to the adjusted vocals 209.

As described in the published paper Bac Nguyen, Fabien Cardinaux, “NVC-Net: End-to-End Adversarial Voice Conversion”, arXiv:2106.00992, to convert an utterance x from a speaker y, here the user, to a speaker \tilde{y} with an utterance \tilde{x}, mapping of the utterance x into a content embedding through the content encoder c=E_{c}(x) is performed, as described above. The raw audio, here the adjusted vocals 209, is generated from the content embedding c conditioned on a target speaker embedding \tilde{z}, i.e., \tilde{x}=G(c,\tilde{z}). The content encoder is a fully-convolutional neural network (see CNN 1207 in FIG. 12), which can be applied to any input sequence length. It maps the raw audio waveform to an encoded content representation. The speaker encoder produces an encoded speaker representation from an utterance, wherein Mel-spectrograms are extracted from the audio signals and are used as inputs to the speaker encoder. The generator maps the content and speaker embeddings back to raw audio. The CNN described above may be an NVC-Network.

The timbrical analysis 901 which is performed as the feature extraction described in FIG. 2 above and the audio processing performed on the user's vocals signal based on the timbrical information 902 may be implemented as described in the published paper Bac Nguyen, Fabien Cardinaux, “NVC-Net: End-to-End Adversarial Voice Conversion”, arXiv:2106.00992.

The timbrical information 902, is for example, a set of timbrical parameters that describe the voice of the original singer, i.e. the original vocals 203. The feature extraction 205 process of FIG. 2 is implemented here as timbrical analysis 901 process performed by e.g. the speaker encoder, wherein the source separation (see 202 in FIG. 2) which is performed on the audio (see 201 in FIG. 2) decomposes the audio in original vocals 203 and accompaniment (see 204 in FIG. 2).

The extracted timbrical information 902 is then applied to the user's vocals signal to obtain the adjusted vocals (see 209 in FIG. 2). In this manner the adjusted vocals sound like the vocals of the original singer (original vocals). The extracted timbrical information may be applied to the user's vocals using e.g. a voice cloning algorithm, or the like. Then the adjusted vocals are mixed with the accompaniment to obtain a mixed audio, as described in more detail in FIG. 2 above.

It should be noted that the feature extraction process (see 205 in FIG. 2) may extract other features than the ones described in more detail in FIGS. 3 to 9 above. For example, as extracted features, parameters for a typical effect chain, e.g. compressor, equalizer, flanger, chorus, delay, vocoder, etc., may be extracted by performing feature extraction on the separated source, e.g. the original vocals. These extracted parameters, which may be parameters for conventional audio effects, are applied to the user's signal, e.g. the user's vocals to match the original signal, e.g. the original vocals signal.

### Play-Along Process Extracting Distortion Information from a Separated Vocal Track

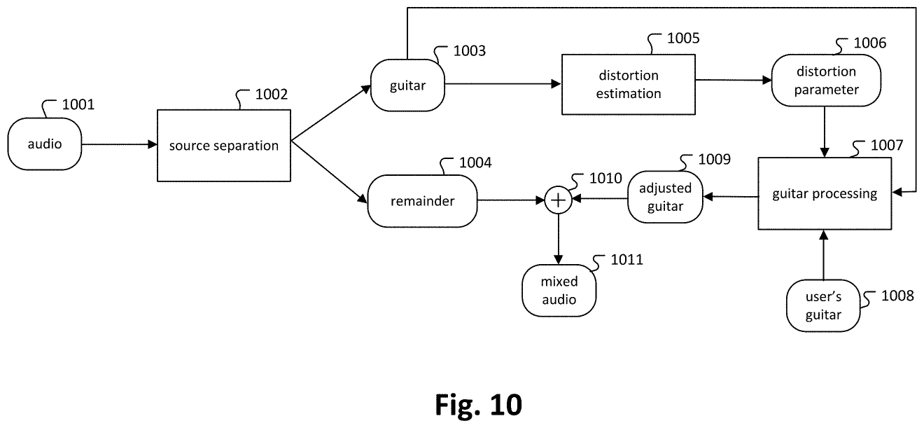

FIG. 10 schematically shows an embodiment of a play-along process based on source separation and feature extraction, wherein distortion estimation is performed as feature extraction in order to extract useful information from the guitar signal, which allows the user to play his guitar track with the original guitar effects.

An audio 1001, i.e. an audio signal (see 1 in FIG. 1) containing multiple sources (see 1, 2, . . . , K in FIG. 1), with, for example, multiple channels (e.g. Mᵢₙ=2) e.g. a piece of music, is input to source separation 1002, e.g. audio source separation, and decomposed into separations (see separated sources 2a-2d and residual signal 3 in FIG. 1) as it is described with regard to FIG. 1 above. In the present embodiment, the audio 1001 is decomposed into one separated source 2, namely guitar 1003, and into a residual signal 3, namely remaining signal 1004, which includes the remaining sources of the audio signal, apart from the guitar signal 1003. Distortion estimation 1005 is performed on the guitar signal 1003, which can be a guitar's audio waveform, to obtain distortion parameters 1006. Based on the distortion parameters 1006 and on the guitar signal 1003, guitar processing 1007 is performed on user's guitar signal, received by a microphone, to obtain adjusted guitar 1009. A mixer 1010 mixes the adjusted guitar 1009 with the remaining signal 1004 to obtain a mixed audio 1011.

The distortion parameters may for example comprise a parameter that describes the amount of distortion (called “drive”) applied to a clean guitar signal, ranging from 0 (clean signal) to 1 (maximum distortion).

In the embodiment of FIG. 10, the separated source 2 is the guitar signal and the residual signal 3 is the remaining signal, without limiting the present embodiment in that regard. Alternatively, the separated source 2 may be the bass signal and the residual signal 3 may be the remaining sources of the audio signal, apart from the bass. Still alternatively, the separated source 2 may be the drums signal and the residual signal 3 may be the remaining sources of the audio signal, apart from the drums.

It should be noted that other parameters than the distortion parameters 1006 may be extracted. For example, information about other effects that have been applied to the original guitar signal may be extracted, e.g. information about delay, compressor, reverberation and the like. The skilled person may choose any parameters to be extracted according to the needs of the specific use case. Still further, the skilled person may choose any number of parameters to be extracted according to the needs of the specific use case, e.g. one or more processing parameters.

It should be further noted that all the above described processes, namely the source separation 1002, and the distortion estimation 1005 can be performed in real-time, e.g. “online” with some latency. For example, they could be directly run on the smartphone, smartwatch of the user/in his headphones, Bluetooth device, or the like.

It should be noted that the user's guitar signal 1008 may be a captured audio signal captured by a instrument pickup, for example a transducer that captures, or senses mechanical vibrations produced by musical instruments, such as an electric guitar or the like.

It should also be noted that after the audio mixing process described in the embodiments of FIGS. 2 to 10, a quality score may be computed on the user's performance, for example, by running a simple comparison between the user's signal and the original signal, e.g. the user's vocals and the original vocal signal (see 203 and 208 in FIGS. 2 to 9), or the user's guitar signal and original guitar signal (see 1003 and 1008 in FIG. 10), to provide as feedback to the user after the song ended. In this case, the feature extraction process is not performed, e.g. it outputs the input signal, while the audio processing may output the user's signal without modifying it. The audio processing may also compare the original signal, e.g. original vocals signal and the user's signal, e.g. user's vocals signal, and may implement a scoring algorithm that evaluate the user's performance, such that a score is provided to the user as acoustic feedback output by a loudspeaker system (see 1209 in FIG. 12) of an electronic device (see 1200 in FIG. 12), or as visual feedback displayed by a display unit of the electronic device (see 1200 in FIG. 12), or displayed by a display unit of an external electronic device which communicates with the electronic device (see 1200 in FIG. 12) with an Ethernet interface (see 1206 in FIG. 12), a Bluetooth interface (see 1204 in FIG. 12), or a WLAN interface (see 1205 in FIG. 12) included in the electronic device (see 1200 in FIG. 12).

### Flow-Diagram for a Generic Play/Sing-Along Process

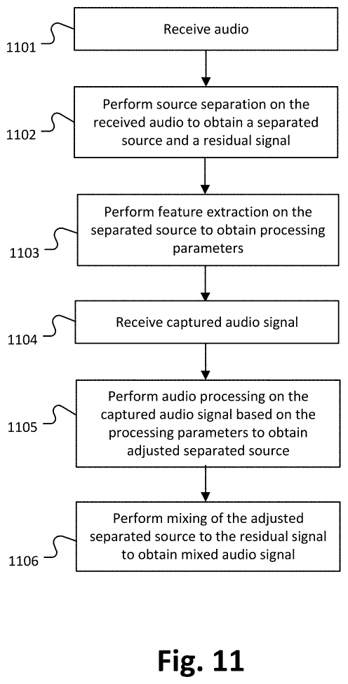

FIG. 11 shows a flow diagram visualizing a method for a generic play/sing-along process based on source separation and feature extraction to obtain a mixed audio signal.

At 1101, the source separation (see 202, 1002 in FIGS. 2 and 10) receives an audio signal (see 201, 1001 in FIGS. 2 and 10). At 1102, source separation (see 202, 1002 in FIGS. 2 and 10) is performed on the received audio signal (see 201, 1001 in FIGS. 2 and 10) to obtain a separated source (see 203, 1003 in FIGS. 2, 3, 7 and 10) and a residual signal (see 204, 1004 in FIGS. 2 and 10). At 1103, feature extraction (see 205, 301, 701 and 1005 in FIGS. 2, 3, 7 and 10) is performed on the separated source (see 203, 1003 in FIGS. 2, 3, 7 and 10) to obtain one or more processing parameters (see 206, 302, 702 and 1006 in FIGS. 2, 3, 7 and 10). At 1104, the audio processing (see 207, 401, 801 and 1007 in FIGS. 2, 4, 8 and 10) receives a captured audio signal (see 208, 1008 in FIGS. 2, 6, 8 and 10) and at 1105, audio processing (see 207, 401, 404, 801 and 1007 in FIGS. 2, 4, 8 and 10), e.g. vocals processing, guitar processing or the like, is performed on the captured audio signal based on the separated source and the one or more extracted processing parameters to obtain adjusted separated source (see 209, 1009 in FIGS. 2, 6, 8 and 10). At 1106, a mixer (see 210, 1010 in FIGS. 2 and 10) performs mixing of the adjusted separated source (see 209, 1009 in FIGS. 2, 6, 8 and 10) with the residual signal (see 204, 1004 in FIGS. 2 and 10) to obtain a mixed audio signal (see 211, 1011 in FIGS. 2 and 10). The mixed audio and/or the processed audio may be output to a loudspeaker system of a smartphone, of a smartwatch, of a Bluetooth, or the like, such as headphones and the like.

As discussed herein, the source separation may decompose the audio signal into a separated source and a residual signal, namely into vocals and accompaniment, without limiting the present embodiment in that regard. Alternatively, the separated source may be guitar, drums, bass or the like and the residual signal may be the remaining source of the audio signal being input to the source separation, apart from the separated source. The captured audio signal may be user's vocals in the case where the separated source is vocals or may be user's guitar signal in the case where the separated source is a guitar signal, and the like.

### Implementation

FIG. 12 shows a block diagram depicting an embodiment of an electronic device that can implement the processes of audio mixing based on an enable signal and audio processing. The electronic device 1200 comprises a CPU 1201 as processor. The electronic device 1200 further comprises a microphone array 1210, a loudspeaker array 1209 and a convolutional neural network unit 1207 that are connected to the processor 1201. The processor 1201 may for example implement a mixer 210, 404 and 1011 that realize the processes described with regard to FIGS. 2, 4 and 10 in more detail. The CNN 1207 may for example be an artificial neural network in hardware, e.g. a neural network on GPUs or any other hardware specialized for the purpose of implementing an artificial neural network. The CNN 1207 may for example implement a source separation 301, a feature extraction 205, an audio processing 207 that realize the processes described with regard to FIGS. 2, 3, 4, 5, 7, 8, 9 and 10 in more detail. Loudspeaker array 1209 may be headphones, e.g. on-ear, in-ear, over-ear, wireless headphones and the like, or may consist of one or more loudspeakers that are distributed over a predefined space and is configured to render any kind of audio, such as 3D audio. The microphone array 1310 may be configured to receive speech (voice), vocals (signer's voice), instrumental sounds or the like, for example, when the user signs a song or plays an instrument (see audio 201 in FIGS. 2, and 10). The microphone array 1210 may be configured to receive speech (voice) commands via automatic speech recognition to operate the electronic device 1200. The electronic device 1200 further comprises a user interface 1208 that is connected to the processor 1201. This user interface 1208 acts as a man-machine interface and enables a dialogue between an administrator and the electronic device. For example, an administrator may make configurations to the system using this user interface 1208. The electronic device 1200 further comprises an Ethernet interface 1306, a Bluetooth interface 1204, and a WLAN interface 1205. These units 1204, 1205, 1206 act as I/O interfaces for data communication with external devices. For example, additional loudspeakers, microphones, and video cameras with Ethernet, WLAN or Bluetooth connection may be coupled to the processor 1201 via these interfaces 1204, 1205 and 1206.

The electronic device 1200 further comprises a data storage 1202 and a data memory 1203 (here a RAM). The data memory 1203 is arranged to temporarily store or cache data or computer instructions for processing by the processor 1201. The data storage 1202 is arranged as a long-term storage, e.g., for recording sensor data obtained from the microphone array 1210. The data storage 1202 may also store audio data that represents audio messages, which the electronic device may output to the user for guidance or help.

It should be noted that the description above is only an example configuration. Alternative configurations may be implemented with additional or other sensors, storage devices, interfaces, or the like.

It should be recognized that the embodiments describe methods with an exemplary ordering of method steps. The specific ordering of method steps is, however, given for illustrative purposes only and should not be construed as binding.

It should also be noted that the division of the electronic device of FIG. 12 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Note that the present technology can also be configured as described below.

(1) An electronic device comprising circuitry configured to
perform source separation (202; 1002) on an audio signal (201; 1001) to obtain a separated source (2) and a residual signal (3);
perform feature extraction (205; 1005) on the separated source (2) to obtain one or more processing parameters (206; 1006); and
perform audio processing (207; 1007) on a captured audio signal (208; 1008) based on the one or more processing parameters (206; 1006) to obtain an adjusted separated source (209; 1009).

(2) The electronic device of (1), wherein the circuitry is further configured to perform mixing (210; 1010) of the adjusted separated source (209; 1009) with the residual signal (3) to obtain a mixed audio signal (211, 1011).

(3) The electronic device of (1) or (2), wherein the circuitry is configured to perform audio processing (207; 1007) on the captured audio signal (208; 1008) based on the separated source (2) and the one or more processing parameters (206; 1006) to obtain the adjusted separated source (209; 1009).

(4) The electronic device of any one of (1) to (3), wherein the separated source (2) comprises an original vocals signal (203), the residual signal (3) comprises accompaniment (204) and the captured audio signal (208; 1008) comprises a user's vocals signal (208).

(5) The electronic device of (4), wherein the circuitry is further configured to
perform pitch analysis (301) on the original vocals signal (203) to obtain original vocals pitch (302) as processing parameter; and
perform pitch analysis (301) on the user's vocals signal (208) to obtain user's vocals pitch (402).

(6) The electronic device of (5), wherein the circuitry is further configured to a perform vocals pitch comparison (401) based on the user's vocals pitch (402) and on the original vocals pitch (302) to obtain a pitch comparison result (403).

(7) The electronic device of (6), wherein the circuitry is further configured to perform vocals mixing (404) of the original vocals signal (203) with the user's vocals signal (208) based on the pitch comparison result (403) to obtain the adjusted vocals signal (209).

(8) The electronic device of (4), wherein the circuitry is further configured to perform reverberation estimation (701) on the original vocals signal (203) to obtain reverberation time (702) as processing parameter.

(9) The electronic device of (8), wherein the circuitry is further configured to perform reverberation (801) on the user's vocals signal (208) based on the reverberation time (702) to obtain the adjusted vocals signal (209).

(10) The electronic device of (4), wherein the circuitry is further configured to perform timbrical analysis (901) on the original vocals signal (203) to obtain timbrical information (902) as processing parameter.

(11) The electronic device of (10), wherein the circuitry is further configured to perform audio processing on the user's vocals signal (208) based on the timbrical information (902) to obtain the adjusted vocals signal (209).

(12) The electronic device of (4), wherein the circuitry is further configured to perform effect chain analysis on the original vocals signal (203) to obtain a chain effect parameter as processing parameter.

(13) The electronic device of (12), wherein the circuitry is further configured to perform audio processing on the user's vocals signal (208) based on the chain effect parameter to obtain the adjusted vocals signal (209).

(14) The electronic device of any one of (1) to (13), wherein the circuitry is further configured to compare the captured audio signal (208; 1008) with the separated source (2) to obtain a quality score estimation and provide a quality score as feedback to a user based on the quality score estimation.

(15) The electronic device of any one of (1) to (14), wherein the captured audio signal (208; 1008) is acquired by a microphone (1310) or instrument pickup.

(16) The electronic device of (15), wherein the microphone (1310) is a microphone of a device (1300) such as a smartphone, headphones, a TV set, a Blu-ray player.

(17) The electronic device of any one of (2) to (16), wherein the mixed audio signal (211, 1011) is output to a loudspeaker system (1309).

(18) The electronic device of any one of (1) to (17), wherein the separated source (2) comprises a guitar signal (1003), the residual signal (3) comprises a remaining signal (1004) and the captured audio signal (208; 1008) comprises a user's guitar signal (1008).

(19) The electronic device of (18), wherein the circuitry is further configured to perform distortion estimation (1005) on the guitar signal (1003) to obtain a distortion parameter (1006), as processing parameter and perform guitar processing (1007) on the user's guitar signal (1008) based on the guitar signal (1003) and the distortion parameter (1006) to obtain an adjusted guitar signal (1009).

(20) A method comprising:
performing source separation (202; 1002) on an audio signal (201; 1001) to obtain a separated source (2) and a residual signal (3);
performing feature extraction (205; 1005) on the separated source (2) to obtain one or more processing parameters (206; 1006); and
performing audio processing (207; 1007) on a captured audio signal (208; 1008) based on the one or more processing parameters (206; 1006) to obtain an adjusted separated source (209; 1009).

(21) A computer program comprising instructions which, when the program is executed by a computer, cause the computer to carry out the method of (20).

1. An electronic device comprising circuitry configured to
perform source separation on an audio signal to obtain a separated source and a residual signal;
perform feature extraction on the separated source to obtain one or more processing parameters; and
perform audio processing on a captured audio signal based on the one or more processing parameters to obtain an adjusted separated source.

2. The electronic device of claim 1, wherein the circuitry is further configured to perform mixing of the adjusted separated source with the residual signal to obtain a mixed audio signal.

3. The electronic device of claim 1, wherein the circuitry is configured to perform audio processing on the captured audio signal based on the separated source and the one or more processing parameters to obtain the adjusted separated source.

4. The electronic device of claim 1, wherein the separated source comprises an original vocals signal, the residual signal comprises accompaniment and the captured audio signal comprises a user's vocals signal.

5. The electronic device of claim 4, wherein the circuitry is further configured to
perform pitch analysis on the original vocals signal to obtain original vocals pitch as processing parameter; and
perform pitch analysis on the user's vocals signal to obtain user's vocals pitch.

6. The electronic device of claim 5, wherein the circuitry is further configured to a perform vocals pitch comparison based on the user's vocals pitch and on the original vocals pitch to obtain a pitch comparison result.

7. The electronic device of claim 6, wherein the circuitry is further configured to perform vocals mixing of the original vocals signal with the user's vocals signal based on the pitch comparison result to obtain the adjusted vocals signal.

8. The electronic device of claim 4, wherein the circuitry is further configured to perform reverberation estimation on the original vocals signal to obtain reverberation time as processing parameter.

9. The electronic device of claim 8, wherein the circuitry is further configured to perform reverberation on the user's vocals signal based on the reverberation time to obtain the adjusted vocals signal.

10. The electronic device of claim 4, wherein the circuitry is further configured to perform timbrical analysis on the original vocals signal to obtain timbrical information as processing parameter.

11. The electronic device of claim 10, wherein the circuitry is further configured to perform audio processing on the user's vocals signal based on the timbrical information to obtain the adjusted vocals signal.

12. The electronic device of claim 4, wherein the circuitry is further configured to perform effect chain analysis on the original vocals signal to obtain a chain effect parameter as processing parameter.

13. The electronic device of claim 12, wherein the circuitry is further configured to perform audio processing on the user's vocals signal based on the chain effect parameter to obtain the adjusted vocals signal.

14. The electronic device of claim 1, wherein the circuitry is further configured to compare the captured audio signal with the separated source to obtain a quality score estimation and provide a quality score as feedback to a user based on the quality score estimation.

15. The electronic device of claim 1, wherein the captured audio signal is acquired by a microphone or instrument pickup.

16. The electronic device of claim 15, wherein the microphone is a microphone of a device such as a smartphone, headphones, a TV set, a Blu-ray player.

17. The electronic device of claim 2, wherein the mixed audio signal is output to a loudspeaker system.

18. The electronic device of claim 1, wherein the separated source comprises a guitar signal, the residual signal comprises a remaining signal and the captured audio signal comprises a user's guitar signal.

19. The electronic device of claim 18, wherein the circuitry is further configured to perform distortion estimation on the guitar signal to obtain a distortion parameter, as processing parameter and perform guitar processing on the user's guitar signal based on the guitar signal and the distortion parameter to obtain an adjusted guitar signal.

20. A method comprising:
performing source separation on an audio signal to obtain a separated source and a residual signal;
performing feature extraction on the separated source to obtain one or more processing parameters; and
performing audio processing on a captured audio signal based on the one or more processing parameters to obtain an adjusted separated source.

21. A computer program comprising instructions which, when the program is executed by a computer, cause the computer to carry out the method of claim 20.
